(19) United States
(12) Patent Application Publication
(10) Pub. No.: US 2023/0011273 A1
(43) Pub. Date: Jan. 12, 2023

(54) RECHARGEABLE BATTERY

(71) Applicant: SAMSUNG SDI CO., LTD., Yongin-si, Gyeonggi-do (KR)

(72) Inventors: Jong-Ha LEE, Yongin-si (KR); Byoungmin CHUN, Yongin-si (KR)

(21) Appl. No.: 17/757,436

(22) PCT Filed: Sep. 8, 2020
(86) PCT No.: PCT/KR2020/012103

§ 371 Date: Jun. 15, 2022

(30) Foreign Application Priority Data
Dec. 19, 2019 (KR) 10-2019-0171022

(51) Int. Cl. H01M 50/172; H01M 50/147; H01M 50/188; H01M 50/153; H01M 50/545; H01M 50/109

(52) U.S. Cl. CPC H01M 50/172; H01M 50/109; H01M 50/147; H01M 50/153; H01M 50/188; H01M 50/545

(57) ABSTRACT

A rechargeable battery according to an embodiment of the present invention includes: an electrode assembly including a first electrode, a second electrode, and a separator between the first electrode and the second electrode; a case including an opening in one side and receiving the electrode assembly; and a cap assembly combined to the opening and closing and sealing the case, wherein the cap assembly includes a cap plate combined to the opening and including a terminal hole, a terminal plate combined to the top of the cap plate to cover the terminal hole, an upper insulator disposed at the top of the cap plate to be provided between the cap plate and the terminal plate, and a lower insulator disposed at a bottom of the cap plate and including an edge disposed near the case and extending downward.

### TECHNICAL FIELD

The present invention relates to a rechargeable battery. More particularly, the present invention relates to a very small rechargeable battery.

### BACKGROUND ART

Unlike a primary battery that is incapable of being recharged, a rechargeable battery can be repeatedly recharged and discharged. A small-capacity rechargeable battery is used for small portable electronic devices such as mobile phones, notebook computers, camcorders, and the like, while a large-capacity rechargeable battery is used as a motor-driving power source for a hybrid vehicle.

As typical rechargeable batteries, there are a nickel-cadmium (Ni—Cd) battery, a nickel-metal hydride (Ni—MH) battery, a lithium (Li) battery, a lithium ion (Li—ion) battery, etc. Particularly, the lithium ion rechargeable battery has an operating voltage of about thrice as high as that of the Ni—Cd battery or Ni—MH battery that is widely used as a power supply for electronic devices. In addition, the lithium ion rechargeable battery has been widely used because its energy density per unit weight is high.

Particularly, as demands on wearable devices such as headphones, earphones, smartwatches, and medical devices attachable to bodies and using Bluetooth are recently increasing, needs of very small rechargeable batteries with high energy density are increasing.

For example, the very small rechargeable battery includes a coin cell or a button cell. In general, the coin cell or the button cell has a low height, and is coupled through crimping between a cell cup, which is the half of the housing, and a cell top. Accordingly, battery capacity is reduced.

On the contrary, when the housing of the coin cell or the button cell has a structure combined by welding (a welded combination between the case and the cap plate), an electrode assembly may be damaged by welding heat. When an additional electrode terminal is provided to the housing with the structure combined by welding, a thickness of a portion in which the electrode terminal is installed may be increased, and battery capacity may be reduced.

### DISCLOSURE

The present invention has been made in an effort to provide a rechargeable battery for increasing battery capacity by reducing a thickness of a portion in which an electrode terminal is installed.

The present invention has been made in an effort to provide a rechargeable battery for protecting an electrode assembly from welding heat for combination between a case and a cap plate.

An embodiment of the present invention provides a rechargeable battery including: an electrode assembly including a first electrode, a second electrode, and a separator between the first electrode and the second electrode; a case including an opening in one side and receiving the electrode assembly; and a cap assembly combined to the opening and closing and sealing the case, wherein the cap assembly includes a cap plate combined to the opening and including a terminal hole, a terminal plate combined to the top of the cap plate to cover the terminal hole, an upper insulator disposed at the top of the cap plate to be provided between the cap plate and the terminal plate, and a lower insulator disposed at a bottom of the cap plate and including an edge disposed near the case and extending downward.

The lower insulator may include a base portion having a first thickness and disposed at the bottom of the cap plate, and a blocking portion connected to an edge of the base portion and having a second thickness that is greater than the first thickness.

The case may include a bottom plate and a lateral plate extending upward from an edge of the bottom plate, and the blocking portion may be disposed between the lateral plate of the case and the electrode assembly.

The cap assembly may further include a connecting insulator contacting a circumference portion of the terminal hole and passing through the terminal hole to connect the upper insulator and the lower insulator.

The upper insulator, the lower insulator, and the connecting insulator may be integrally connected.

The cap plate, the terminal plate, the upper insulator, the lower insulator, and the connecting insulator may be integrally formed by an insert molding method.

The rechargeable battery may further include: a first electrode tab for electrically connecting the first electrode and the terminal plate; and a second electrode tab for electrically connecting the second electrode and the case and the cap plate.

The electrode assembly may be wound with respect to a rotation axis by which the first electrode, the second electrode, and the separator are arranged in a perpendicular direction to a lowest side of the case.

The first electrode tab may extend to a top of the electrode assembly and may be welded to an internal lateral side of the terminal plate, and the second electrode tab may extend to a bottom of the electrode assembly and may be welded to an internal lateral side of the case.

The rechargeable battery may further include: a first insulating member disposed between the first electrode tab and an upper side of the electrode assembly; and a second insulating member disposed between the second electrode tab and a lower side of the electrode assembly.

The terminal plate may include an inserting portion inserted into the terminal hole.

The connecting insulator may be disposed between the inserting portion and the terminal hole.

An upper side of the terminal plate may be flat.

An upper side of a position corresponding to the inserting portion on the terminal plate may be concave downward.

An edge of the upper insulator may extend upward to cover a cross-section of an edge of the terminal plate.

The case may be cylindrical, and the cap plate may be welded and combined to an opening of the case.

A ratio of height to diameter of the rechargeable battery may be equal to or less than 1.

According to the embodiment of the present invention, the battery capacity may be increased by reducing the thickness of the cap assembly.

Further, the electrode assembly may be protected from the welding heat caused by the welding of the case and the cap plate.

### DESCRIPTION OF THE DRAWINGS

FIG. 1 shows a perspective view of a rechargeable battery according to a first embodiment of the present invention.

FIG. 2 shows an exploded perspective view of a rechargeable battery according to a first embodiment of the present invention.

FIG. 3 shows a cross-sectional view in a direction of III-III of FIG. 2.

FIG. 4 shows an enlarged cross-sectional view of a cap assembly of a rechargeable battery according to a first embodiment of the present invention.

FIG. 5 shows a perspective view of a rechargeable battery according to a second embodiment of the present invention.

FIG. 6 shows a cross-sectional view in a direction of VI-VI of FIG. 5.

FIG. 7 and FIG. 8 show an enlarged drawing of a cap assembly of a rechargeable battery according to a second embodiment of the present invention.

FIG. 9 shows a cross-sectional view of a rechargeable battery according to a third embodiment of the present invention.

### MODE FOR INVENTION

In the following detailed description, only certain embodiments of the present invention have been shown and described, simply by way of illustration. As those skilled in the art would realize, the described embodiments may be modified in various different ways, all without departing from the spirit or scope of the present invention. Like reference numerals designate like elements throughout the specification and the drawings.

The drawings and description are to be regarded as illustrative in nature and not restrictive. Like reference numerals designate like elements throughout the specification.

The size and thickness of each configuration shown in the drawings are arbitrarily shown for better understanding and ease of description, but the present invention is not limited thereto.

Throughout the specification, when it is described that a part is “connected (in contact with, coupled)” to another part, the part may be “directly connected” to the other element or “connected” to the other part through a third part. Unless explicitly described to the contrary, the word “comprise” and variations such as “comprises” or “comprising” will be understood to imply the inclusion of stated elements but not the exclusion of any other elements.

The rechargeable battery according to an embodiment of the present invention is a very small battery, and it may be a coin cell or a button cell. The coin cell or the button cell is a battery in a thin coin shape or a button shape, and it represents a battery of which a ratio of a height to a battery diameter is equal to or less than 1.

The coin cell or the button cell is generally cylindrical, so the cross-section in a horizontal direction is circular, and without being limited, may also be oval or polygonal. In this instance, the diameter is set to be a maximum distance with reference to the horizontal direction of the battery, and the height is set to be a minimum distance to a flat uppermost side of the battery from a flat lowest side thereof.

However, the coin cell or the button cell is an example of the present invention, and without being limited thereto, the present invention may be a cylindrical battery or a pin-type battery. A case in which the rechargeable battery according to an embodiment of the present invention is a coin cell or a button cell will now be exemplarily described in detail.

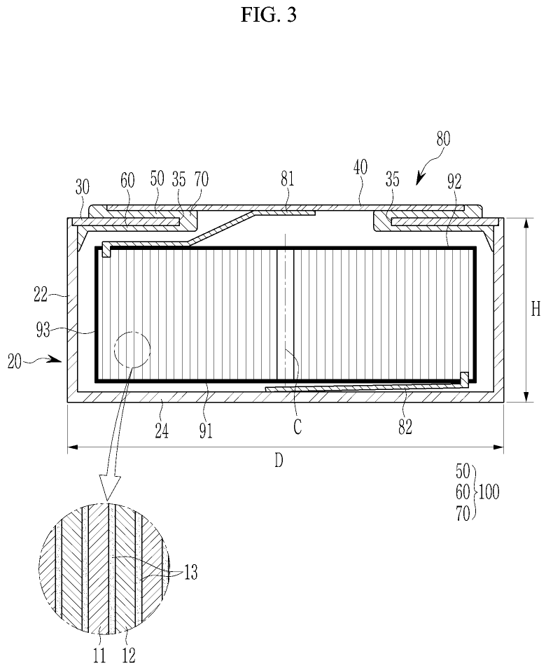

Meanwhile, directions such as “inside” and “inner side” mean a direction toward an electrode assembly 10, and directions such as “outside” and “outer side” mean the opposite direction. Further, terms “top”, “upward”, “bottom”,“downward”, “height direction”, “vertical direction”, and “longitudinal direction” refer to a direction that is perpendicular to a bottom plate 24 (refer to FIG. 3) of the case 20 (refer to FIG. 3), and terms “horizontal direction” and “transverse direction” refer to a direction that is parallel to the bottom plate 24 (refer to FIG. 3).

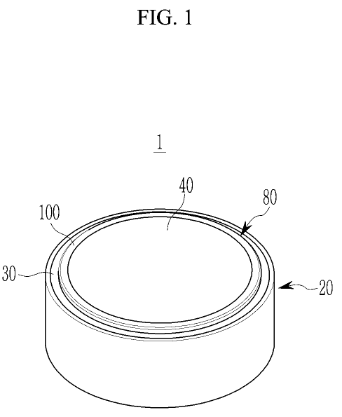

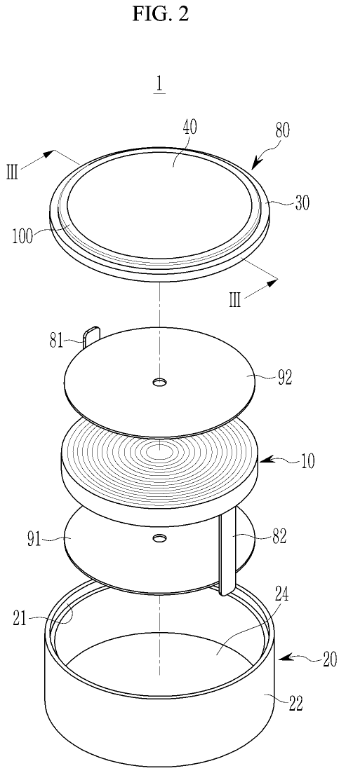

FIG. 1 shows a perspective view of a rechargeable battery according to a first embodiment of the present invention, FIG. 2 shows an exploded perspective view of a rechargeable battery according to a first embodiment of the present invention, and FIG. 3 shows a cross-sectional view in a direction of III-III of FIG. 2.

Referring to FIG. 1 to FIG. 3, the rechargeable battery 1 includes an electrode assembly 10, a case 20, and a cap assembly 80.

The electrode assembly 10 includes a first electrode 11 (e.g., a negative electrode) and a second electrode 12 (e.g., a positive electrode) installed on respective sides of a separator 13 that is an electrical insulating material, and is formed by winding the first electrode 11, the separator 13, and the second electrode 12. Accordingly, the electrode assembly 10 may have a jelly-roll shape, and is configured to charge and discharge currents.

In this instance, a winding axis C (refer to FIG. 3) of the electrode assembly 10 may be arranged in parallel to a height direction (direction that is perpendicular to the lowest side of the case) of the case 20, and an upper side and a lower side of the electrode assembly 10 may be flat and may be parallel to each other.

Although not shown in the drawing, the electrode assembly 10 may provide a center pin on the position of the winding axis C. When a first electrode tab 81 and a second electrode tab 82 are welded to a terminal plate 40 and the case 20, respectively, the center pin makes the first electrode tab 81 and the terminal plate 40 stick to one end and makes the second electrode tab 82 and the case 20 stick to another end so that the welding task may be easily performed. However, the center pin may not be provided depending on welding schemes or a process for assembling a rechargeable battery.

The first electrode 11 and the second electrode 12 will be exemplified to be a negative electrode and a positive electrode, and without being limited thereto, the first electrode 11 and the second electrode 12 may respectively be a positive electrode and a negative electrode.

The negative electrode 11 (or a first electrode) has a long strip shape, and includes a negative coated region generated by applying a negative active material layer to a current collector of a metal film (e.g., a foil of Cu) and a negative uncoated region to which no active material is applied. The negative uncoated region may be positioned on one end in a length direction of the negative electrode.

The positive electrode 12 (or a second electrode) has a long strip shape, and includes a positive coated region generated by applying a positive active material layer to a current collector of a metal film (e.g., a foil of Al) and a positive uncoated region to which no active material is applied. The positive uncoated region may be positioned on one end in a length direction of the positive electrode.

A first electrode tab 81 is fixed and installed in the first electrode 11, and a second electrode tab 82 is fixed and installed in the second electrode 12. The first electrode tab 81 and the second electrode tab 82 are respectively installed in the negative uncoated region and the positive electrode uncoated region and extend to be parallel to the winding axis of the electrode assembly 10, and an end portion may be bent toward the winding axis. For example, the bent end portions of the first electrode tab 81 and the second electrode tab 82 may be disposed on the top and the bottom of the electrode assembly 10.

The first electrode tab 81 is made of an electrically conductive material such as copper or nickel, and is electrically connected to the terminal plate 40 of the cap assembly 80. For example, the bent end portion of the first electrode tab 81 may be connected to an internal lateral side of the terminal plate 40 of the cap assembly 80 by welding (e.g., laser beam welding).

The second electrode tab 82 is made of an electrically conductive material such as nickel or aluminum, and is electrically connected to the case 20 or a cap plate 30 of the cap assembly 80. For example, the bent end portion of the second electrode tab 82 may be connected to the internal lateral side (or an internal lowest side) in the case 20 by welding (e.g., laser beam welding).

Referring to FIG. 2 and FIG. 3, the rechargeable battery 1 may include a first insulating member 91 provided between the second electrode tab 82 and the electrode assembly 10, and a second insulating member 92 provided between the first electrode tab 81 and the electrode assembly 10.

For example, the first insulating member 91 and the second insulating member 92 may be respectively disposed on the lower side and the upper side of the electrode assembly 10. Accordingly, the first insulating member 91 may be disposed between the lower side of the electrode assembly 10 and the bent second electrode tab 82, and the second insulating member 92 may be disposed between the upper side of the electrode assembly 10 and the bent first electrode tab 81.

The first insulating member 91 and the second insulating member 92 may have disk shapes to cover the upper side and the lower side of the electrode assembly 10, and without being limited thereto, they may cover part of the upper side and the lower side of the electrode assembly 10, and may include an opening so that the center pin or the first and second electrode tabs 81 and 82 may penetrate the same.

Electrical contact between the second electrode tab 82 and the electrode assembly 10 may be prevented through the first insulating member 91, and electrical contact between the first electrode tab 81 and the electrode assembly 10 may be prevented through the second insulating member 92. Electrical contact between the electrode assembly 10 and the case 20 may be prevented through the first insulating member 91 and the second insulating member 92.

An external circumferential surface of the electrode assembly 10 may be surrounded by an insulating tape 93. By this, an outside of the electrode assembly 10 may be protected, and a space between the external circumferential surface of the electrode assembly 10 and an inside of the case 20 may be electrically insulated.

The electrode assembly 10 may be inserted through the opening 21 formed in one side of the case 20, and may be received into the case 20. The case 20 includes a bottom plate 24 and a lateral plate 22, and sets a space for receiving the electrode assembly 10 and the electrolyte solution therein. The bottom plate 24 and the lateral plate 22 may be integrally formed, or the bottom plate 24 and the lateral plate 22 may be connected to each other by a welding method.

For example, the case 20 has a cylindrical shape, and may have a circular opening 21 in the upper end so that the cylindrical electrode assembly 10 may be inserted. In this instance, as shown in FIG. 2 and FIG. 3, a step may be formed on the edge of the opening 21, that is, the internal lateral side of the upper end portion of the lateral plate 22 so that the cap assembly 80 may be supported.

The case 20 is electrically connected to the second electrode tab 82 so it may be made of a metallic material with electrical conductivity.

Referring to FIG. 1 to FIG. 3, the cap assembly 80 may close and seal the opening 21 of the case 20, and may be welded and combined to the opening 21. The cap assembly 80 includes a cap plate 30, a terminal plate 40, and an insulator 100.

The insulator 100 may electrically a space between the cap plate 30 and the terminal plate 40 and may seal the same.

The insulator 100 may include an upper insulator 50, a lower insulator 60, and a connecting insulator 70 for connecting them. The upper insulator 50, the lower insulator 60, and the connecting insulator 70 may be made of a same material and may be integrally formed. For example, the insulator 100 may pass through a circumference portion of the terminal hole 35 from the upper side of the cap plate 30 and may reach the lower side of the cap plate 30.

Regarding the cap assembly 80, the cap plate 30 and the terminal plate 40 that are metallic materials, and the insulator 100 (including the upper insulator 50, the lower insulator 60, and the connecting insulator 70) that is an electrically insulating material, may be integrally formed according to an insert molding process. Accordingly, durability of the cap assembly 80 may be improved, and the cap assembly 80 may be made into a thin disk. Accordingly, the battery capacity may be increased.

As an example, the cap plate 30 and the terminal plate 40 may be made of various metallic materials with electrical conductivity. The upper insulator 50, the lower insulator 60, and the connecting insulator 70 may be made of a resin material with electrical insulation.

The insulator 100 may protect the electrode assembly 10 from the welding heat for combining the case 20 and the cap plate 40, which will be described in a later portion of the present specification.

A configuration of the cap assembly 80 in the rechargeable battery 1 according to a first embodiment of the present invention will now be described in detail.

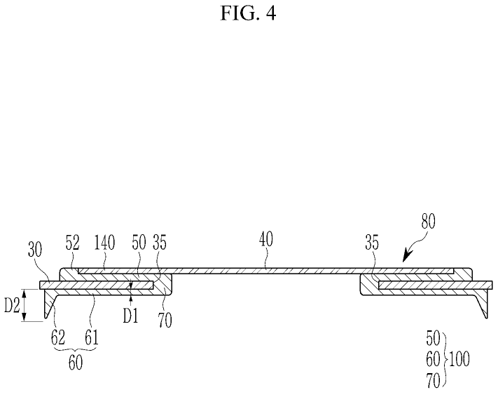

FIG. 4 shows an enlarged cross-sectional view of a cap assembly of a rechargeable battery according to a first embodiment of the present invention.

Referring to FIG. 2 to FIG. 4, the cap assembly 80 generally has a thin disk shape, and the cap plate 30 and the terminal plate 40 may be concentrically disposed.

The cap plate 30 may be formed as an annular plate with a terminal hole 35 in a center. The terminal hole 35 may be circular, and without being limited thereto, it may have various shapes such as a polygon in addition to the circular shape. The exterior circumference portion of the cap plate 30 may be combined to the opening 21 of the case 20.

The cap plate 30 may be welded and combined to the case 20, and has a same polarity as the case 20. For example, the cap plate 30 may have the same polarity as the second electrode 12 electrically connected to the case 20.

The terminal plate 40 is installed at a top of the cap plate 30 to cover the terminal hole 35, and has a polarity that is different from that of the cap plate 30. That is, the terminal plate 40 is electrically connected to the first electrode 11. Accordingly, an insulator 100 made of an insulating material may be disposed between the cap plate 40 and the terminal plate 40.

The first electrode tab 81 may be connected to the internal lateral side of the terminal plate 40 by laser beam welding, and the terminal plate 40 is disposed to cover the terminal hole 35 so the first electrode tab 81 contacts the internal lateral side of the terminal plate 40 exposed to the inside through the terminal hole 35 and may then be easily welded.

The terminal plate 40 may have a flat plate shape with a flat upper side. That is, as the upper side of the terminal plate 40 forms a plane, and although not shown, when a pack in which a plurality of rechargeable batteries are connected is configured, a degree of freedom of positions of connection terminals for connecting a plurality of rechargeable batteries may be increased.

The cap plate 30 and the terminal plate 40 may be arranged in parallel to each other and may be combined to each other by the insulator 100 disposed therebetween. In this instance, the cap assembly 80 configured by the cap plate 30, the terminal plate 40, and the insulator 100 may have a generally thin plate shape. Accordingly, the battery capacity may be increased by reducing the thickness of the cap assembly 80, and a wide area of the terminal plate 40 to which an outer terminal is connected may be exposed on the upper side of the cap assembly 80.

As described above, the insulator 100 insulates a space between the cap plate 30 and the terminal plate 40 and seals the space. The insulator 100 may protect the electrode assembly 10 from the welding heat for combination between the case 20 and the cap plate 30.

The insulator 100 may include an upper insulator 50 positioned at the top of the cap plate 30, a lower insulator 60 positioned at the bottom of the cap plate 30, and a connecting insulator 70 for connecting the upper insulator 50 and the lower insulator 60.

As described above, the cap plate 30 and the terminal plate 40 made of a metallic material, and the insulator 100 made of a resin material, may be integrally formed according to the insert molding method. As the cap plate 30, the terminal plate 40, and the insulator 100 are combined by the insert molding method, the insulator 100 may pass through the circumference portion of the terminal hole 35 from the top of the cap plate 30 and may be sequentially connected to the bottom of the cap plate 30. A combination force and a sealing force between the cap plate 30 and the terminal plate 40, and the insulator 100, that are made of different materials, may be increased.

In a plan view, the insulator 100 may have an annular shape that corresponds to the shape of the cap plate 30, and in a cross-sectional view, the insulator 100 may have a double-layered structure in which the upper insulator 50 and the lower insulator 60 are arranged in parallel to each other with a space in which the cap plate 30 is provided therebetween.

Referring to FIG. 4, the upper insulator 50 may be disposed between the cap plate 30 and the terminal plate 40 and may be arranged in parallel to them. The edge of the upper insulator 50 (in a direction becoming distant from the terminal hole 35) may extend upward to cover an end side of the edge of the terminal plate 40. That is, the upper insulator 50 may have a structure in which a border portion 52 that is convex upward is provided on the edge, and the terminal plate 40 is combined to an inside of the border portion 52.

Referring to FIG. 4, the lower insulator 60 may be disposed at the bottom of the cap plate 30. The lower insulator 60 may cover the entire side excluding a portion of the edge to which the lateral plate 22 of the case 20 is combined from among a bottom side of the cap plate 30.

Regarding the lower insulator 60, the edge disposed near the case 20 may extend downward. The lower insulator 60 may thus protect the electrode assembly 10 from the welding heat for combination between the case 20 and the cap plate 30.

In detail, the lower insulator 60 may include a base portion 61 positioned at the bottom of the cap plate 30, and a blocking portion 62 connected to the edge of the base portion (in a direction becoming distant from the terminal hole 35).

Referring to FIG. 4, the base portion 61 may be positioned at the bottom of the cap plate 30 and in parallel to the cap plate 30, and may be combined to the bottom side of the cap plate 30. The base portion 61 may have a predetermined thickness, for example, a first thickness D1.

The blocking portion 62 may be sequentially connected to the edge of the base portion 61 so an outermost end side may be disposed near the lateral plate 22 of the case 20. The blocking portion 62 may extend downward so that the thickness thereof may be greater than that of the base portion 61, and it may have a second thickness D2 that is greater than that of the base portion 62.

The blocking portion 62 may be sequentially connected to the base portion 61 and may be integrally formed therewith. As shown in FIG. 4, the thickness of the blocking portion 62 may become greater as approaching the edge, and without being limited thereto, the blocking portion 62 may have a constant thickness that is greater than that of the base portion 61.

That is, the blocking portion 62 extends in a perpendicular direction, differing from the base portion 61 that extends in a horizontal direction. The blocking portion 62 may be positioned between the lateral plate 22 of the case 20 and the electrode assembly 10.

As described, the lower insulator 60 is configured with the base portion 61 and the blocking portion 62 that have different thicknesses from each other, thereby maximizing the battery capacity and protecting the electrode assembly 10 from the welding heat. In addition, there is no need to provide an additional insulation means for insulating a space between the first electrode tab 81 and the cap plate 30 with different polarities, or an additional protection means for protecting the electrode assembly 10 from the welding heat.

The connecting insulator 70 connects the upper insulator 50 and the lower insulator 60, and may be positioned on the circumference portion of the terminal hole 35 of the cap plate 30. That is, the upper insulator 50 positioned at the top of the cap plate 30 and the lower insulator 60 positioned at the bottom of the cap plate 30 may be connected to each other by the connecting insulator 70 contacting the circumference portion of the terminal hole 35 of the cap plate 30 and passing through the terminal hole 35. Accordingly, the combination force between the insulator 100 and the cap plate 30 may be increased, and the first electrode tab 81 may be prevented from contacting the circumference portion of the terminal hole 35.

A second embodiment of the present invention will now be described. The same configurations as those according to a first embodiment will be omitted, and different configurations will now be described.

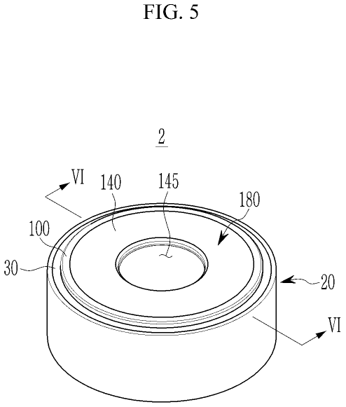

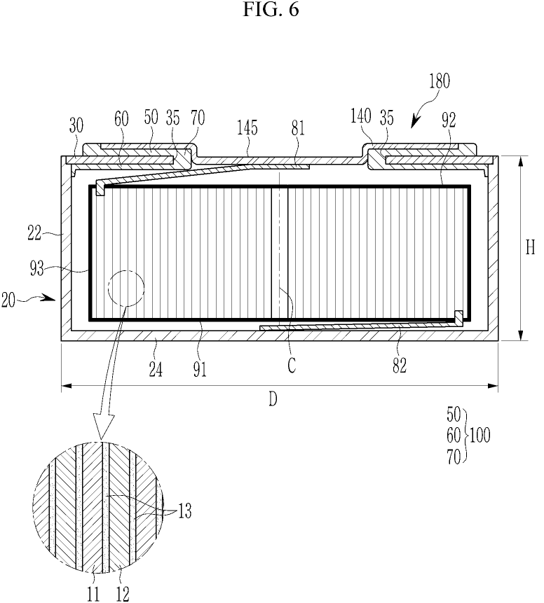

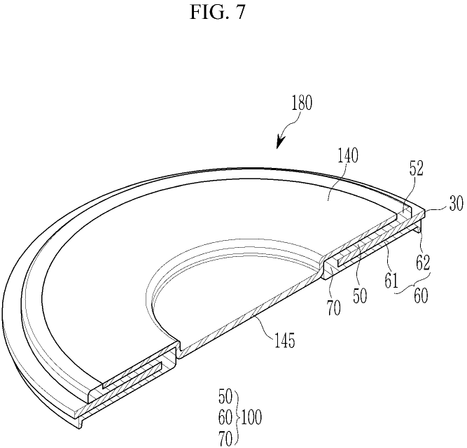

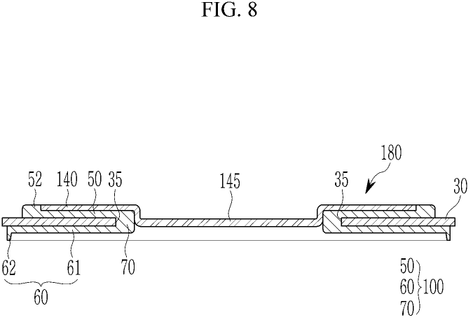

FIG. 5 shows a perspective view of a rechargeable battery according to a second embodiment of the present invention, and FIG. 6 shows a cross-sectional view in a direction of VI-VI of FIG. 5. FIG. 7 and FIG. 8 show an enlarged drawing of a cap assembly of a rechargeable battery according to a second embodiment of the present invention.

Referring to FIG. 5 to FIG. 8, the rechargeable battery 2 according to a second embodiment of the present invention corresponds to the above-described rechargeable battery 1 according to a first embodiment excluding the cap assembly 180. That is, the rechargeable battery 2 may include a cap assembly 180 in which an inserting portion 145 is formed on the terminal plate 140.

The terminal plate 140 does not have a flat plate shape but has a shape in which part thereof is dented. In detail, an inserting portion 145 inserted into the terminal hole 35 of the cap plate 30 may be formed in the terminal plate 140.

As shown in FIG. 5 and FIG. 7, the upper side of the terminal plate 140 is not flat, and the inserting portion 145 has a shape that is concave downward. The bottom side of the terminal plate 140 is not flat, and the inserting portion 145 has a shape that is convex inward. In a plan view, the inserting portion 145 may be circular, and without being limited thereto, it may have various shapes such as a polygon. The inserting portion 145 is formed on the position that corresponds to the terminal hole 35 of the cap plate 30, and has a shape to be inserted into the terminal hole 35.

The inserting portion 145 is integrally formed with the terminal plate 140. For example, the terminal plate 140 may be manufactured by drawing-processing the terminal plate of a metallic material in a flat plate shape with a predetermined thickness.

That is, the exterior circumference portion of the terminal plate 140 is arranged at the top of the cap plate 30 and in parallel to the cap plate 30, and the inserting portion 145 of the terminal plate 140 is inserted into the terminal hole 35 so it may be arranged at a position that is similar to the cap plate 30 in the perpendicular direction or may be arranged at a position that is lower than that of the cap plate 30.

Accordingly, when compared to the case in which no inserting portion is formed in the terminal plate in a like way of the first embodiment, the first electrode tab 81 drawn out of the electrode assembly 10 may be disposed nearer the internal lateral side of the terminal plate 140, that is, the internal lateral side of the inserting portion 145, so the welding task between the first electrode tab 81 and the internal lateral side of the inserting portion 145 may be easily performed.

A connecting insulator 70 may be positioned between the inserting portion 145 of the terminal plate 140 and the terminal hole 35 of the cap plate 30. In detail, the inserting portion 145 may be positioned in the terminal hole 35, and the connecting insulator 70 may be filled in the space between the inserting portion 145 and the terminal hole 35. As the terminal plate 140 and the cap plate 30 have different polarities, the inserting portion 145 inserted into the terminal hole 35 may be prevented from contacting the circumference portion of the terminal hole 35. The contact between the inserting portion 145 and the circumference portion of the terminal hole 35 may be prevented by the connecting insulator 70, thereby allowing electrical insulation.

The inserting portion 145 of the terminal plate 140 is positioned in the terminal hole 35 of the cap plate 30, and the connecting insulator 70 is filled in the space between the inserting portion 145 and the terminal hole 35 so the combination force between the terminal plate 140 and the insulator 100 may be increased.

A third embodiment of the present invention will now be described. The same configurations as the above-described first and second embodiments will be omitted, and different configurations will now be described.

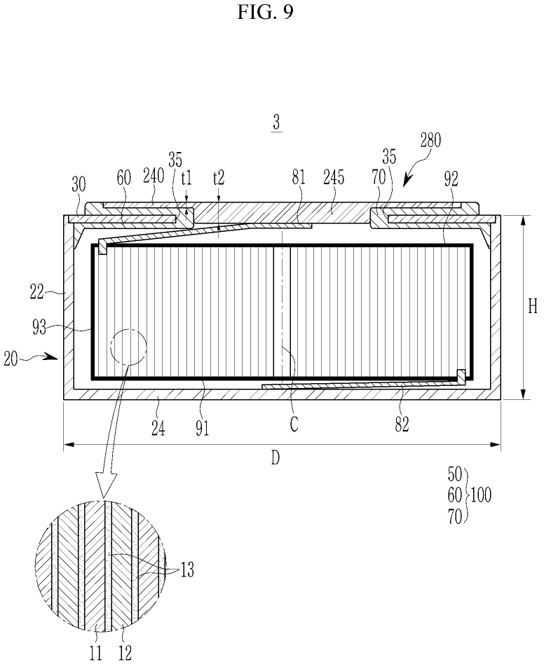

FIG. 9 shows a cross-sectional view of a rechargeable battery according to a third embodiment of the present invention.

Referring to FIG. 9, the rechargeable battery 3 according to a third embodiment of the present invention corresponds to the above-described rechargeable batteries 1 and 2 according to the first and second embodiments excluding the cap assembly 280. That is, the rechargeable battery 3 according to a third embodiment of the present invention may include a cap assembly 280 in which an inserting portion 245 with a shape that is different from the above-described second embodiment is formed in the terminal plate 240.

The terminal plate 240 has a planar form with a flat upper side, and a bottom side thereof has an inserting portion 245 of which part is convex inward. In detail, referring to FIG. 9, the exterior circumference portion of the terminal plate 240 has a flat plate shape with the thickness of t1, and it may be arranged at the top of the cap plate 30 and in parallel to the cap plate 30. The inserting portion 245 of the terminal plate 240 has a flat plate shape with the thickness of t2, and is inserted into the terminal hole 35 so it may be disposed on the similar position to the cap plate 30 in the perpendicular direction or may be disposed below the cap plate 30.

As the upper side of the terminal plate 240 forms a plane, and when a pack in which a plurality of rechargeable batteries are connected is configured in a like way of the above-described first embodiment, the degree of freedom of positions of connection terminals for connecting a plurality of rechargeable batteries may be increased. As the inserting portion 245 inserted into the terminal hole 35 is made in the terminal plate 240, the welding task between the first electrode tab 81 and the internal lateral side of the inserting portion 245 may be easily performed in a like way of the second embodiment. As the connecting insulator 70 is filled in the space between the inserting portion 245 and the terminal hole 35, the combination force between the terminal plate 240 and the insulator 100 may be increased.

The above-described rechargeable batteries 1, 2, and 3 according to embodiments of the present invention may be coin cells or button cells, and the ratio H/D of the height H (refer to FIGS. 3, 6, and 9) to the diameter D (refer to FIGS. 3, 6, and 9) may be equal to or less than 1.

As described above, regarding the rechargeable batteries 1, 2, and 3, as the insulator (e.g., the upper insulator 50) is provided at the top of the cap plate 30 to install the terminal plates 40, 140, and 240, the cap assemblies 80, 180, and 280 may be configured to have a thin plate shape.

As the insulator (e.g., lower insulator 60) with a thick edge is installed at the bottom of the cap plate 30, the electrode assembly 10 may be protected from the welding heat.

As the insulator (e.g., the connecting insulator 70) is installed to pass through the circumference portion of the terminal hole 35 of the cap plate 30, the insulator 100 may be formed to be integrally connected to the top and the bottom of the cap plate 30. In this instance, the cap plate 30, the terminal plates 40, 140, and 240, and the insulator 100 may be integrally formed according to the insert molding method.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

### Description of Symbols

1, 2, 3 rechargeable battery 10 electrode assembly
11 first electrode (negative electrode) 12 second electrode (positive electrode)
13 separator 20 case
21 opening 22 lateral plate
24 bottom plate 30 cap plate
35 terminal hole 40, 140, 240 terminal plate
145, 245 inserting portion 50 upper insulator
60 lower insulator 70 connecting insulator
81 first electrode tab 82 second electrode tab
91 first insulating member 92 second insulating member
80, 180, 280 cap assembly 100 insulator

1. A rechargeable battery comprising:
an electrode assembly including a first electrode, a second electrode, and a separator between the first electrode and the second electrode;
a case including an opening in one side and receiving the electrode assembly; and
a cap assembly combined to the opening and closing and sealing the case,
wherein the cap assembly includes
a cap plate combined to the opening and including a terminal hole,
a terminal plate combined to the top of the cap plate to cover the terminal hole,
an upper insulator disposed at the top of the cap plate to be provided between the cap plate and the terminal plate, and
a lower insulator disposed at a bottom of the cap plate and including an edge disposed near the case and extending downward.

2. The rechargeable battery of claim 1, wherein
the lower insulator includes a base portion having a first thickness and disposed at the bottom of the cap plate, and a blocking portion connected to an edge of the base portion and having a second thickness that is greater than the first thickness.

3. The rechargeable battery of claim 2, wherein
the case includes a bottom plate and a lateral plate extending upward from an edge of the bottom plate, and
the blocking portion is disposed between the lateral plate of the case and the electrode assembly.

4. The rechargeable battery of claim 1, wherein
the cap assembly further includes a connecting insulator contacting a circumference portion of the terminal hole and passing through the terminal hole to connect the upper insulator and the lower insulator.

5. The rechargeable battery of claim 4, wherein
the upper insulator, the lower insulator, and the connecting insulator are integrally connected.

6. The rechargeable battery of claim 5, wherein
the cap plate, the terminal plate, the upper insulator, the lower insulator, and the connecting insulator are integrally formed by an insert molding method.

7. The rechargeable battery of claim 1, further comprising:
a first electrode tab for electrically connecting the first electrode and the terminal plate; and
a second electrode tab for electrically connecting the second electrode and the case, and the cap plate.

8. The rechargeable battery of claim 7, wherein
the electrode assembly is wound with respect to a rotation axis by which the first electrode, the second electrode, and the separator are arranged in a perpendicular direction to a lowest side of the case.

9. The rechargeable battery of claim 8, wherein
the first electrode tab extends to a top of the electrode assembly and is welded to an internal lateral side of the terminal plate, and
the second electrode tab extends to a bottom of the electrode assembly and is welded to an internal lateral side of the case.

10. The rechargeable battery of claim 9, further comprising:
a first insulating member disposed between the first electrode tab and an upper side of the electrode assembly; and
a second insulating member disposed between the second electrode tab and a lower side of the electrode assembly.

11. The rechargeable battery of claim 4, wherein the terminal plate includes an inserting portion inserted into the terminal hole.

12. The rechargeable battery of claim 11, wherein
the connecting insulator is disposed between the inserting portion and the terminal hole.

13. The rechargeable battery of claim 11, wherein an upper side of the terminal plate is flat.

14. The rechargeable battery of claim 11, wherein
an upper side of a position corresponding to the inserting portion on the terminal plate is concave downward.

15. The rechargeable battery of claim 1, wherein
an edge of the upper insulator extends upward to cover a cross-section of an edge of the terminal plate.

16. The rechargeable battery of claim 1, wherein
the case is cylindrical, and the cap plate is welded and combined to an opening of the case.

17. The rechargeable battery of claim 1, wherein
a ratio of height to diameter of the rechargeable battery is equal to or less than 1.
